(19) United States
(12) Patent Application Publication
(10) Pub. No.: US 2010/0193124 A1
(43) Pub. Date: Aug. 5, 2010

(54) Method of Lining a Well or a Pipe Using an Inflatable Bladder

(75) Inventors: Frédéric Nicolas, Rennes (FR); Yoann Riou, Laille (FR); Benjamin Saltel, Cintre (FR); Jean-Louis Saltel, Le Rheu (FR)

Correspondence Address: LERNER, DAVID, LITTENBERG,;KRUMHOLZ & MENTLIK, 600 SOUTH AVENUE WEST, WESTFIELD, NJ, 07090, US

(73) Assignee: SALTEL INDUSTRIES, Bruz (FR)

(21) Appl. No.: 12/668,726

(22) PCT Filed: Jul. 8, 2008
(86) PCT No.: PCT/EP2008/058873

§ 371 Date: Jan. 12, 2010

(30) Foreign Application Priority Data
Jul. 12, 2007 (FR) 07/05060

(51) Int. Cl. E03B 3/15; E21B 43/10; E21B 29/10; B32B 37/00

(52) U.S. Cl. 156/294; 166/384

(57) ABSTRACT

According to the method, a cylindrical tube (1) is inserted into the well or the pipe (C) that is to be lined, after which part of the tube is radially expanded using an inflatable bladder (2) so that the wall of the tube is pressed against that of the well or of the pipe (C). According to the invention, this expansion is achieved by moving the already-expanded bladder axially and continuously along inside the tube (1) over a travel corresponding to the length of the tube or of the region of tube that is to be expanded. Fields of water or oil production.

The present invention relates to a method for lining a well or a pipe, for example a casing, having a portion to be treated in order to seal it, notably to be repaired and/or plugged.

It more particularly but not mandatorily applies to the field of water production or oil production.

In the following of the present description, the invention will be applied as an example in the field of water production.

Water catchment boreholes are drilled in the ground and generally include a continuous line or casing, made by a succession of cylindrical steel tubes of relatively short length (of the order of 6 m to 12 m for example) welded or screwed to each other, end to end.

With this casing, once it is cemented against the natural wall of the well, a seal of the entire height of the well may be obtained, in order to avoid any contamination between the various ground layers.

During the course of time, it happens that a portion or the totality of the wall of the casing has to be sealed, notably when it has been degraded, for example by premature wear and/or corrosion, or when the perforations intended for letting through the water have to be blocked, in particular when they produce undesirable fluids which risk crossing the wall of the casing and penetrating inside the latter.

In order to repair the wall of the casing, it is known how to line the existing wall by placing a lining with a smaller diameter than that of the existing casing and to cement by injection the annular space formed by the old casing and the new tube. This method has the drawback of strongly reducing the diameter of the borehole since the annular space required for good cementing is relatively significant, generally larger than 30 mm on the diameter. Further proper coaxiality of both tubes is difficult to ensure, in particular in the curved portions of the well, which may cause poor cementing and cause contamination between the different layers of the ground.

Other methods consist of positioning in the existing casing, a lining with a slightly smaller diameter and proceeding with radial expansion of the new line so that it will be flattened against the wall to be treated.

This expansion is generally produced by means of a mandrel.

For this purpose, use is made of a rigid, for example steel, cylindrical mandrel provided with a frusto-conical or conical (shape of an artillery shell) end portion. The diameter of the cylindrical portion corresponds to the inner diameter intended to be given to the lining.

During the operation, the mandrel is continuously moved inside the tube forming the lining, axially, from one end of the latter, by pushing or pulling it axially.

The frusto-conical or conical portion is used for pushing back the wall of the tube gradually and radially so as to flatten it against the internal surface of the casing.

In order to reduce the significant friction generated by the operation, certain mandrels are rotary or provided with rolls or rotary rollers.

A drawback of this technique is that the mandrel has a well-defined invariable cross-section so that a problem is posed when it is passed into the portions of the casing which do not have a cylindrical section with a strictly adapted diameter; these notably are shrunken portions and/or portions with a non-circular, for example ovalized, section.

In order to solve this difficulty, mandrels were proposed, the periphery of which is provided with a set of adjacent segments which are normally inscribed in a cylindrical envelope but are individually mobile relatively to each other in order to follow as close as possible the actual profile of the casing during the progression of the mandrel.

A mandrel of this type for example is the subject of document U.S. Pat. No. 6,688,397.

However, this kind of tool is relatively complex and fragile; further, when it is expanded, interstices which are not in contact with the wall to be expanded, are formed between the different segments, so that the obtained final section has a relatively irregular shape.

Expansion methods by hydroforming have also been proposed, which use an inflatable bladder, with a flexible and elastic membrane in rubber or in elastomeric material, the radial expansion of which is produced by introducing into the bladder a pressurized fluid, notably a high pressure liquid.

The state of the art on this subject may be illustrated by the technical document in English dated from Jun. 30, 2000, of the Australian Corporation IPI (Inflatable Packers International Pty Ltd) entitled “Slim-line Re-lining”, as well as by document EP-A 1 657 365.

According to these techniques, a tube of great length, formed with tube sections attached end to end beforehand are introduced into the well or the pipe to be lined, after which it is proceeded with radial expansion of the tube, over its entire length, so that its wall will be applied against that of the well or of the pipe; this expansion is achieved by a succession of successive positionings of the inflatable bladder along the tube with, in each position, a crimping operation by inflating the bladder and then deflating the latter so as to bring it to a position adjacent to the previous one, and so forth all along the tube.

Such a method is very costly when the question is of expanding great lengths because its application requires a lot of time, because of the significant time of each successive inflation/deflation phase.

Further, significant wear of the crimping tool occurs, because of the strong mechanical stresses to which it is subject at each step. It is therefore necessary to change this tool periodically, because its lifetime is relatively limited.

As an indication, the maximum number of expansion operations of such a tool with an inflatable bladder is generally about fifty.

Under these conditions, as an example, if a length of 1,000 m has to be lined with a pitch of 0.5 m, it is necessary to successively proceed with 2,000 inflation/deflation operations which require the use of about forty different tools.

The invention is aimed at overcoming these difficulties by proposing a method with which a large area of the casing may be lined rapidly and economically.

The invention may be applied not only to a casing as described above, but also to any well dug into the ground or to any pipe, whether buried or not, and this is why the lining of a well or of a pipe, the latter being able to be a casing of an open well or any other conduit, vertical, horizontal or oblique, rectilinear or curved, is stated in the description and the following claims.

The object of the invention is therefore a method for lining a well or a pipe, for example a casing by means of an inflatable bladder, the totality or only certain portions of the well and of the pipe having to be treated, notably repaired, and/or to be plugged.

As this is known, a cylindrical tube (possibly formed with tube sections attached end to end beforehand) is introduced into the well or into the pipe to be lined, after which it is proceeded with radial expansion of the tube by means of an inflatable bladder, so that the wall of the tube will be flattened against that of the well or of the pipe.

According to the invention, it is proceeded with this expansion, not by proceeding stepwise, but by displacing the bladder inflated beforehand axially and continuously inside the tube, over a travel corresponding to the length of the tube to be expanded.

It is understood that by means of this technique, the time required for lining and the wear to which the bladder is subject, are considerably reduced since there are no repeated inflation/deflation phases for the bladder; a single tool or a limited number of tools may therefore be used.

Further, the deformability of the membrane making up the bladder and the fluidity of the hydraulic liquid ensuring its inflation are such that the cross-section of the bladder is not set, unlike that of a mobile mandrel. It may permanently be adapted to the actual profile of the well or of the pipe to be lined, so that the lining may fit portions with a shrunken, widened and/or imperfectly cylindrical (notably ovalized) section.

Moreover, according to a certain number of additional non-limiting features of the invention:
before proceeding with its expansion, the inflatable bladder is positioned in the deflated condition inside the tube facing an end tube portion to be expanded, after which it is inflated so as to ensure radial expansion of this end portion, and it is then displaced in the inflated condition, axially and continuously towards the opposite end;
it is proceeded with the expansion of only certain areas of the tube which are separated by non-expanded areas in which the bladder in the deflated condition is passed;
use is made of an inflatable bladder provided with a filamentary frame with variable winding, which imparts to it in the inflated condition a shape and predetermined calibrated dimensions;
use is made of an inflatable bladder provided with a protective shield consisting of adjacent flexible strips;
the inflatable bladder is displaced in the tube by pulling it by means of a rod;
the inflatable bladder is displaced in the tube by axially pushing it, under the action of a pressurized fluid.

Other features and advantages of the invention will become apparent upon reading the description hereafter, made with reference to the appended drawings, wherein:

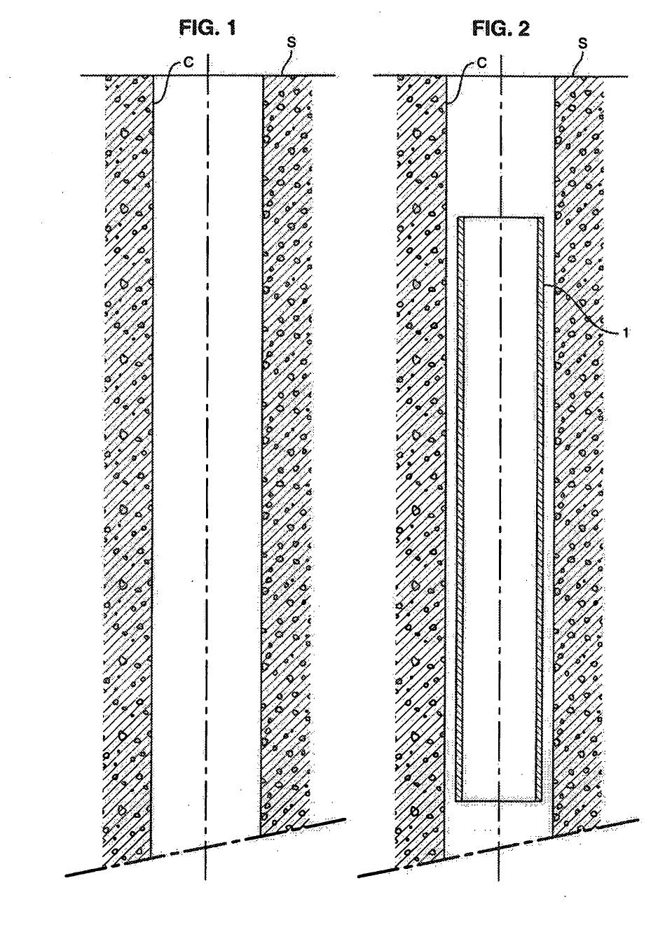

FIG. 1 is an axial sectional view of a well or a pipe to be lined.

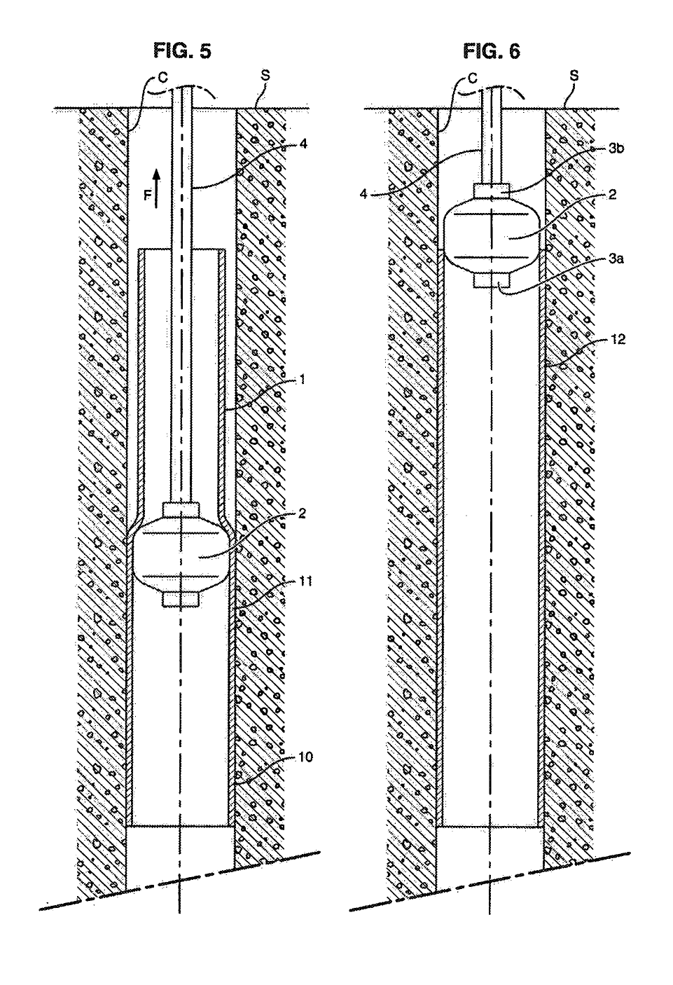

FIGS. 2-6 are schematic views illustrating different steps of the method of the invention for lining the well or the pipe of FIG. 1.

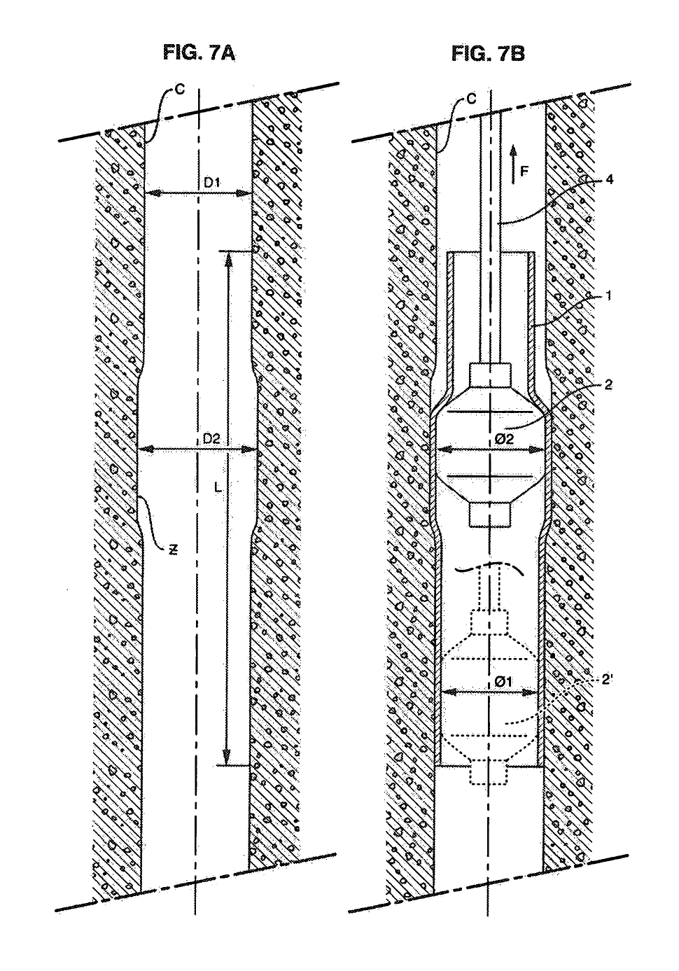

FIG. 7A, similar to FIG. 1, is an axial sectional view of a well or of a pipe to be lined which has a widened sectional area.

FIG. 7B illustrates the operation for lining the well or the pipe of FIG. 7A.

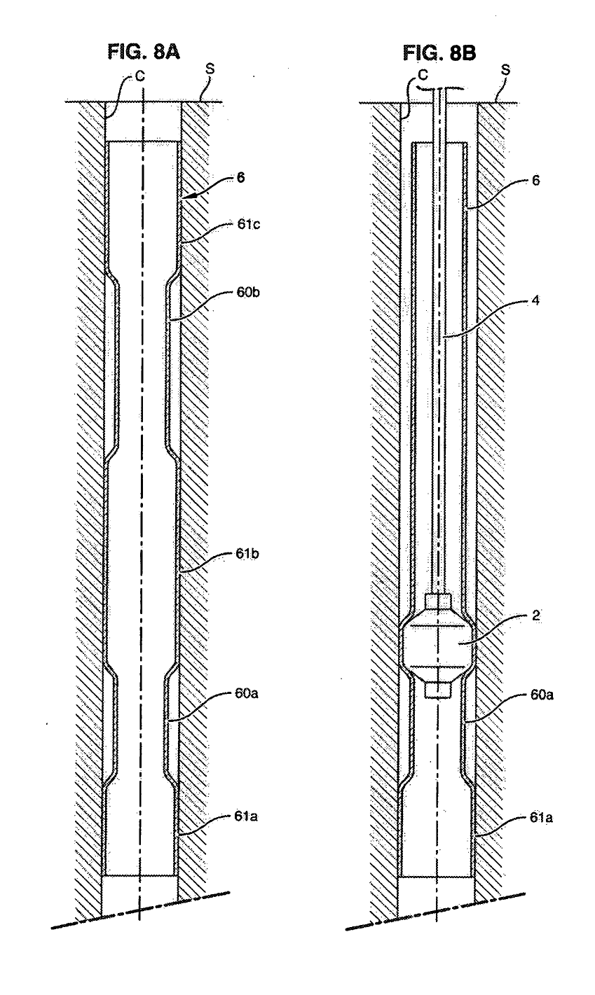

FIG. 8A shows a lining including expanded portions alternating with non-expanded portions.

FIG. 8B illustrates the operation with which the lining of FIG. 8A may be achieved.

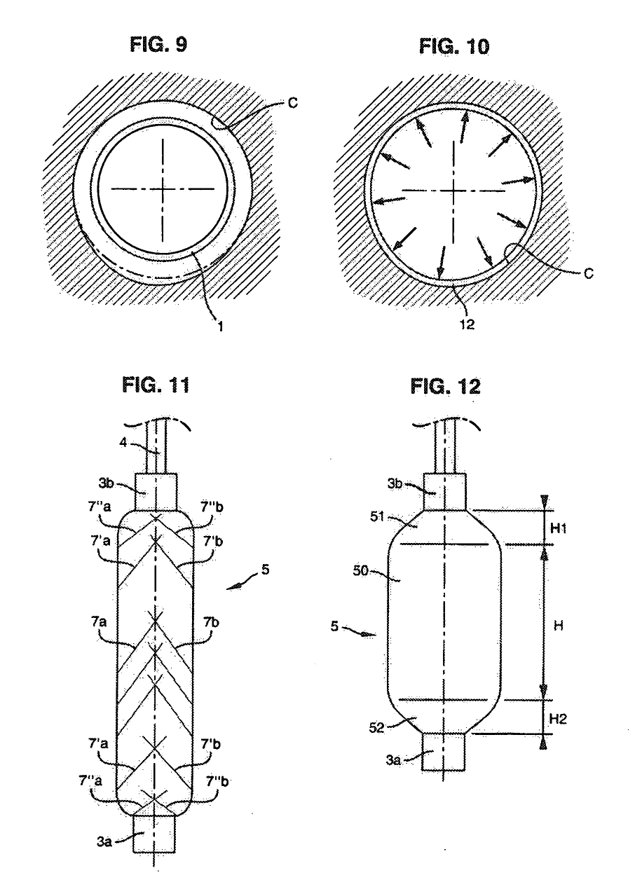

FIGS. 9 and 10 are transverse sectional views of a well or of a pipe with a non-strictly circular cross-section, before and after lining, respectively.

FIGS. 11 and 12 are diagrams of a hydraulic lining tool with an inflatable bladder, with calibrated degree and expansion areas, before and after its expansion, respectively.

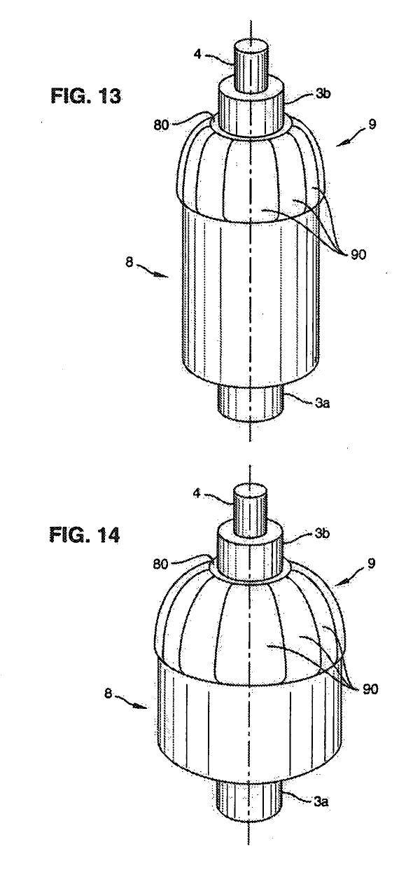

FIGS. 13 and 14 are perspective views of a hydraulic lining tool, with an inflatable bladder equipped with a protective shield, before and after its expansion, respectively.

FIG. 1 illustrates a water catchment borehole with a vertical axis dug in the ground S.

Its wall C with a circular or approximately circular section is rough or for example consists in a deteriorated pipe (or casing) which is intended to be sealed desirably by fitting it out inside with a lining.

In the drawings, in order to facilitate reading, the scale has been substantially enlarged along the radial direction of the conduit (perpendicularly to the axis of the borehole) relatively to the scale used along the axial direction.

Purely as an indication, the well or the pipe for example, has a length of the order of 1,000 m, and a diameter of 160 mm.

In order to line the wall C, a metal tube for example in steel, is used, both ductile and capable of withstanding the corrosion of the medium to which it will be exposed; this tube, referenced as 1 in FIG. 2, has an external diameter slightly smaller than that of the wall C, for example equal to 145 mm; its wall thickness is for example 4 mm. Its length corresponds to the length of wall to be lined, for example about fifty meters.

This tube is advantageously made from the surface S by sealably attaching end-to-end tube sections, which are assembled with each other, for example by welding and then by gradually driving in the tube while it is being made inside the well or the pipe, according to a well-known technique (for example, see document U.S. Pat. No. 2,167,338).

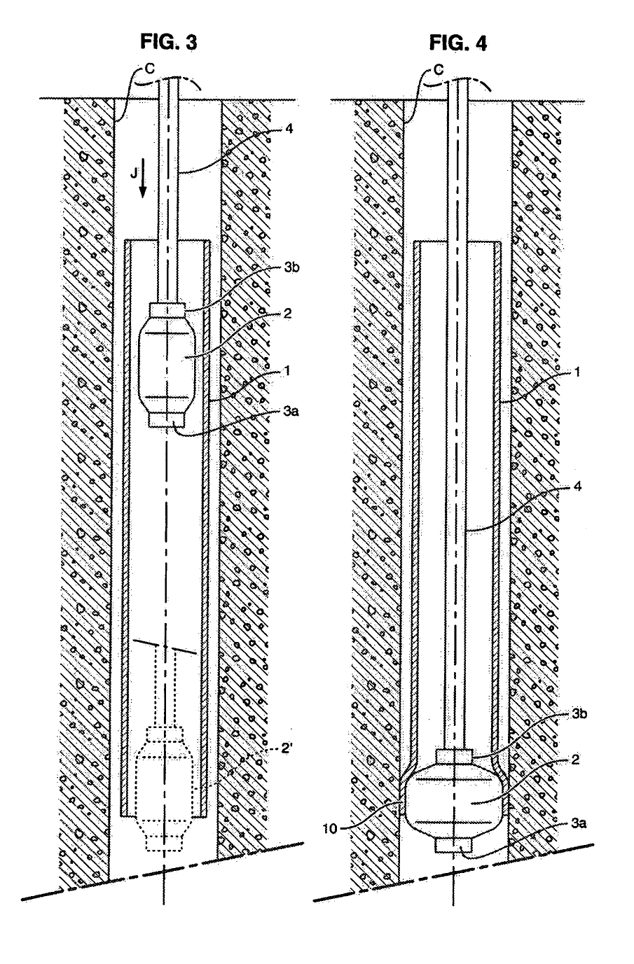

Provision is made for hydroforming this tube 1 by means of a crimping tool in the form of an inflatable bladder, which bears reference 2 in FIGS. 3-6.

Such a bladder with a flexible and elastic membrane is adapted so as to be inserted inside the tube in the deflated condition and to be positioned in a given area of the tube, the expansion of which is desired.

The membrane is mounted on terminal endpieces 3a, 3b.

One of them 3a, located on the side of the bottom of the well will be called “a distal endpiece” and the other one 3b, turned towards the surface will be called “a proximal endpiece”.

The bladder is fed with high pressure liquid, capable of radially expanding the membrane outwards, so that the latter is applied against the wall of the tube and also causes the radial expansion thereof outwards in order to apply it firmly, over a certain length, against the wall C.

This type of tool is usually designated by the expression “inflatable packer”.

The tool is connected to the surface by a rod 4 allowing its handling, its proper positioning, as well as control members allowing it to be inflated and deflated. For this purpose, a conduit for introducing and discharging the inflating liquid may be integrated to said rod 4.

According to the invention, one begins by axially introducing into the well of the pipe C a tube 1 with an adapted length, facing the area to be lined. Means (not shown) for placing, centring and axially immobilizing the tube, of a type known per se, are used for this purpose.

As illustrated in FIG. 3, as the bladder 2 is deflated, it is moved downwards coaxially inside the tube 1 (arrow J, FIG. 3).

When it is positioned facing the distal (lower) end portion of the tube 1, in the position illustrated in dashed lines and referenced as 2′ in FIG. 3, it is inflated.

Thus, as illustrated in FIG. 4, this portion is expanded radially, beyond the elastic limit of the material (in the plastic deformation area) so that its wall 10 is firmly applied irreversibly against the internal wall of the well or of the pipe C, achieving anchoring of the tube at this level.

This achieved anchoring of the distal end portion of the tube which, as a complement to the action of the aforementioned immobilization means, ensures satisfactory retention of the tube along the longitudinal direction.

Once it has been proceeded with this localized expansion according to the invention, the bladder 2 is maintained inflated, and is displaced axially over the whole length to be lined.

In the example illustrated in FIGS. 1-6, it is proceeded with the expansion of the whole of the tube 1.

For this, traction is exerted (from the ground S) on the rod 4, symbolized by the arrow F in FIG. 5, so as to translate the tool 2 continuously from the bottom to the top. This movement of the tool has the effect of gradually pushing back radially the wall 11 of the tube outwards in order to apply it intimately (like the end portion 10), against the internal surface of the well or of the pipe C.

The inflatable bladder ensures this expansion as would a rigid mandrel, from the moment that the pressure of the hydraulic liquid which fills the bladder is sufficient for ensuring creep of the material making up the tube 1, and its deformation beyond the elastic limit.

However, unlike a rigid mandrel, the elastic and flexible membrane of the inflated bladder may deform slightly during the operation in order to accommodate possible profile irregularities of the conduit C.

The operation is finished without having been forced to proceed with successive inflation/deflation phases of the bladder, according to the sought goal.

FIG. 7A shows a conduit profile C with variable section, comprising an area Z, the diameter D2 of which is slightly larger than the one D1 of the remainder of the conduit.

It is desired to line this conduit over a length L including this widened area Z.

By means of the method of the invention, as this is easily understood by simply observing FIG. 7B, it is easy to achieve such lining.

For this purpose, as earlier, one begins by positioning the tube 1 facing the portion to be lined and the bladder 2 (deflated) is moved down axially inside the tube 1 so that it will be facing the lower (or distal) end portion of the tube.

The bladder is then inflated by introducing a high pressure liquid therein, sufficient for expanding radially the wall of the tube 1 beyond its elastic limit in order to apply it intimately against the wall of the conduit C.

In this inflated condition, the external diameter of the tool is Φ1.

This step corresponds to the illustration in dashed lines, referenced as 2′, of the bladder in FIG. 7B. An anchoring area is thereby formed at the base of the tube. As earlier, the inflated bladder is then moved from the bottom to the top by pulling F the rod 4, ensuring a gradual lining of the whole length portion of the conduit C to be lined which is below the area Z.

When the tool 2 reaches the level of this area, it naturally and automatically expands under the effect of the internal pressure of the inflation liquid, to a diameter Φ2>Φ1 which achieves lining of the widened area Z.

Conversely, when this area has been lined, following the shrinkage of the section of the channel in which it is pulled, the tool resumes its diameter Φ1, with which it ensures the lining of the portion to be lined which is above the area Z.

As this will now be explained with reference to FIGS. 8A and 8B, it is possible to line the conduit C by only expanding certain portions of the tube.

In certain cases, it may be of interest to actually maintain determined portions of the tube at their initial diameter, even if it possibly means expanding them later on, depending on the needs and on the constraints related to exploitation of the well or of the pipe.

In this way, FIG. 8A illustrates, as an example, a lining achieved from a tube 6, three portions of which referenced as 61a, 61b and 61c (from the bottom to the top) have been expanded radially and applied against the wall of the conduit C, while the intermediate portions 60a and 60b were not expanded.

To do this, as this is easily understood by simply observing FIG. 8B, one begins by expanding the distal lower portion 61a, by operating as indicated above, after which the bladder 2 is deflated so that it crosses over, by moving from bottom to top, the portion 60a for which the initial diameter is desirably to be retained, and then the bladder is re-inflated in order to expand the portion 61b, and so forth.

FIG. 8B illustrates the expansion of the lower part of the portion 61b following this re-inflation. Continuation of the expansion of this portion is accomplished by moving the inflated bladder from bottom to top until it reaches the entrance of the portion 60b, after which it is deflated.

FIG. 9 shows a conduit C, the section of which is not strictly cylindrical; it has a slightly ovalized shape in certain areas, which deviates from the cylindrical envelope illustrated in dashed lines.

However, notwithstanding this circumstance, because the bladder exerts on the totality of the wall of the tube 1, an internal pressure which is symbolized by the radial arrows in FIG. 10, this wall is forcibly applied against the wall of the conduit over the whole of its section, forming a lining 12 perfectly fitting this section.

Thus, as the inflated bladder axially and gradually progresses in the tube to be expanded, this bladder automatically adapts to the possibly variable section of the latter, this of course within certain limits compatible with the deformability of the tool and with the value of the internal pressure which is applied to it.

It may be advantageous to calibrate the expansion level of the tool and to give a predetermined shape in the inflated condition.

This result may be obtained relatively simply by providing the inflatable membrane with a frame in the form of a network of filaments (carbon fibres or threads for example) advantageously embedded in the thickness of its wall.

This possibility is illustrated in FIGS. 11 and 12 in which the tool with a filamentary frame bears the reference 5.

The network for example comprises two crossed webs of filaments helically wound in opposite directions.

Each web consists of a plurality of juxtaposed adjacent filaments 7 which connect both endpieces 3a and 3b of the tool.

During inflating, the angle α which a tangent to the filament forms relatively to the axial direction, gradually increases following the increase in the diameter of the winding and bringing relatively closer the end endpieces 3a and 3b to each other (like a coil spring for which the turns narrow down).

It is known that in the absence of axial traction, when said angle αattains a value of 54.7°, self-blocking of the network of filaments is observed and the radial expansion cannot continue.

FIG. 12 illustrates the inflated bladder in the shape which is desirably given to it when it is inflated to maximum pressure.

In this condition, it has a main portion 50 with a cylindrical shape, of axial length H, being connected to the distal endpiece 3a through a frusto-conical portion 52 of length H2 and to the proximal endpiece 3b through a frusto-conical portion 51 of length H1, the values of these axial lengths being such that H>H1>H2.

For this, the filaments of the frame are helically wound with variable pitch.

The deflated tool which is substantially cylindrical over the whole of its length is illustrated in FIG. 11.

As this is seen in FIG. 11, the angle α formed by a filament section with a left pitch 7a or with a right pitch 7b relatively to the longitudinal axis of the tool 5 is relatively small in the central portion, the portion which corresponds to the cylindrical portion 50 of the inflated membrane.

At the endpieces 3a and 3b, the angle formed by these filament sections 7″a and 7″b is larger, for example comprised between about 25 and 45°.

In the connection areas, which correspond to the frusto-conical portions 51 and 52 of the inflated membrane, the angle formed by the filament sections 7′a and 7′b is intermediate.

This angle gradually decreases from each endpiece up to the central area. With this, an inflated bladder may be obtained, having a shape similar to the one illustrated in FIG. 12.

The angle α for winding the filaments is naturally selected in such a way that the diameter of the inflated bladder is equal to and preferably slightly greater than the inner diameter of the finished lining which has to be set into place.

Because the expansion level of the tool is limited, the risk of applying to the wall of the tube to be lined, excessive pressure which would be capable of causing creep of the wall by reducing its thickness, is reduced.

The conicity of the portion 51 is useful for assisting with gradual pushing back of the tube during operation, as this is accomplished with a conventional rigid mandrel. This conicity is maintained at a constant value from the moment that the tool is inflated to sufficient pressure.

The conicity of the portion 52 allows progressive connection of the cylindrical portion 50 with the endpiece 3a.

By acting on the variation of the winding angles, it is possible to obtain the desired shapes of the inflated bladder, the portion 51 may for example be conical instead of frusto-conical, and the portion 50 convex (barrel-shaped) instead of being cylindrical.

It should be mentioned that this technique for calibrating the expansion level of an inflatable pipe by applying a filamentary frame with variable pitch is already known per se (see for example DE 1 086 500).

The constitutive material of the elastic membrane is naturally selected in order to suitably withstand high mechanical stresses during the operation, notably at its proximal area (portion 51 in FIG. 12) which pushes back the wall of the tube outwards.

By default, the membrane risks deterioration and/or premature wear.

Further, this material advantageously has a low friction coefficient allowing it to easily slide against the internal face of the tube; this slidability may advantageously be improved by coating the external surface of the membrane with a lubricant, and in particular at this proximal area.

This area, or even the totality of the membrane, may also be coated with an external layer in a suitable anti-friction material.

In the alternative illustrated in FIGS. 13 and 14, the tool, referenced as 8, is provided with a shield 9, the function of which is precisely to promote its sliding while protecting the surface of the inflatable membrane against mechanical aggressions, in particular abrasion related to friction.

The proximal endpiece 3b is provided at its base (tool side) with a ring 80 supporting this shield 9.

The latter consists of a set of pliant (semi-rigid) and flexible strips 90 which are attached to the ring 80 through their upper edge. They are positioned side by side while being slightly superposed at their edges in the fashion of roof tiles.

The strips 90 cover the proximal area of the tool, in which the required high stresses will be exerted in order to expand the tube.

By their elasticity, when the tool is deflated, the strips are applied against the membrane, their border covering level being maximal.

When the bladder is inflated, they are deployed in the fashion of petals of a flower which opens out, and the central area of which corresponds to the ring 80, while remaining applied against the membrane, their border covering level being minimal or even zero.

These strips are made in a mechanically resistant flexible material with high hardness and a low friction coefficient, in metal or in a synthetic material. Their external face is smooth.

It is obvious that there would be no departure from the scope of the invention upon displacing the inflated tool by axial thrust and not by traction. This thrust may be obtained by applying pressure from a fluid, notably hydraulic pressure, on one side of the bladder inflated beforehand.

The tube which is expanded for achieving the lining is not necessarily with a solid wall. This may be an either totally or partly openworked tube in certain areas, for example for setting into place a lining acting as a filter. A lining of this kind, the placement of which is achieved by using a rigid mandrel, is for example known from document U.S. Pat. No. 5,366,012.

The well or the pipe to be lined is of course not necessarily vertical. The invention applies just as well to oblique, horizontal wells and/or to those with a non-rectilinear, notably totally or partly curved configuration.

1. A method for lining a well or a pipe having a wall with an inflatable bladder, comprising:
introducing a length of cylindrical tube into the well or the pipe to be lined;
radially expanding the tube with the inflatable bladder, so the wall of the tube bears against the wall of the well or pipe; and
continuously displacing the bladder axially inside the tube, over the length of the tube or of the tube area to be expanded.

2. The method according to claim 1, further comprising:
positioning the inflatable bladder in deflated condition inside the tube, facing a tube end portion to be expanded;
inflating the inflatable bladder so as to ensure radial expansion of the tube end portion; and
continuously displacing the inflated inflatable bladder axially toward the opposite end of the tube.

3. The method according to claim 1, wherein only certain areas of the tube are radially expanded,
which areas are are separated by non-expanded areas of the tube.

4. The method according to claim 1, wherein the inflatable bladder comprises a filamentary frame having a variable winding; to provide
the inflatable bladder with a predetermined shape and calibrated dimensions when the inflatable bladder is inflated.

5. The method according to claim 1, wherein the inflatable bladder comprises a protective shield having a plurality of adjacent flexible strips.

6. The method according to claim 1, wherein a rod pulls the inflatable bladder within the tube.

7. The method according to claim 1, wherein a pressurized fluid displaces the inflatable bladder axially within the tube.
